(19) United States
(12) Patent Application Publication
(10) Pub. No.: US 2026/0016382 A1
(43) Pub. Date: Jan. 15, 2026

(54) ANISOTROPIC MATERIAL TESTER

(71) Applicant: THE CHILDREN'S MEDICAL CENTER CORPORATION, Boston, MA (US)

(72) Inventors: Peter E. Hammer, Needham, MA (US); David Hoganson, Chestnut Hill, MA (US); Nicholas Kneier, Boston, MA (US)

(73) Assignee: THE CHILDREN'S MEDICAL CENTER CORPORATION, Boston, MA (US)

(21) Appl. No.: 18/992,760

(22) PCT Filed: Jul. 11, 2023
(86) PCT No.: PCT/US2023/069981

§ 371 Date: Jan. 9, 2025

Related U.S. Application Data
(60) Provisional application No. 63/388,184, filed on Jul. 11, 2022.

(51) Int. Cl. G01N 3/08; G01N 3/06

(52) U.S. Cl. CPC G01N 3/08; G01N 3/068; G01N 2203/0282

(57) ABSTRACT

Systems and methods for testing a tissue segment using a tissue testing device are disclosed herein. A tissue testing device may include one or more actuators, a plurality of compliant structures, and a plurality of tissue couplings. The compliant structures may operatively couple the actuators to the tissue couplings such that actuation of the actuators to displace a proximal portion of the compliant structures in turn displaces the tissue couplings. The tissue couplings may be attached to a corresponding tissue segment such that displacement of the tissue couplings provided deformation to the tissue segment. Various parameters of the tissue segment may then be calculated to assist a clinician in optimizing implantation of the tissue segment into a subject.

### RELATED APPLICATIONS

This application claims the benefit under 35 U.S.C. § 119(e) of U.S. provisional application Ser. No. 63/388,184, filed Jul. 11, 2022, the disclosure of which is incorporated herein by reference in its entirety.

### FIELD

Disclosed embodiments are related to devices for testing and quantifying material properties of biological and synthetic materials.

### BACKGROUND

Biomaterials may be used in various types of surgical procedures for both repair and/or replacement of the native tissue. Examples of such surgeries include aortic arch repairs, diaphragm repairs, and/or plastic surgery applications.

### SUMMARY

In some embodiments, a device for testing a biomaterial segment is provided. The device may include a plurality of tissue couplings configured to be selectively engaged with the biomaterial segment around a perimeter of the segment. The device may also include one or more actuators and a plurality of compliant structures configured to operatively couple the one or more actuators with the plurality of tissue couplings. In some embodiments, the one or more actuators are configured to apply an approximately equal magnitude displacement to a proximal portion of each compliant structure of the plurality of compliant structures.

In some embodiments, a method of testing a biomaterial segment is provided. The method may include attaching a plurality of tissue couplings around a perimeter of the biomaterial segment at a plurality of attachment points. The method may also include displacing proximal portions of a plurality of compliant structures attached to the tissue couplings away from the biomaterial segment such that each proximal portion of the plurality of compliant structures is displaced by an approximately equal magnitude displacement. The method may also include applying forces to the biomaterial segment in a plurality of different directions with the plurality of tissue couplings such that the forces and resulting displacements of the plurality of tissue couplings is dependent on one or more properties of the biomaterial segment.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1A is a cross-sectional view of a single axis of a device for testing a tissue segment, according to one embodiment;

FIG. 1B is a top view of the device of FIG. 1A;

FIG. 2A is a top view of a device for testing a tissue segment in a non-actuated state, according to one embodiment;

FIG. 2B is a top view of the device of FIG. 2A in an actuated state;

FIG. 3A is a cross-sectional view of a device for testing a tissue segment in a non-actuated state, according to one embodiment;

FIG. 3B is a cross sectional view of the device of FIG. 3A in an actuated state;

FIG. 4A is a cross-sectional view of a device for testing a tissue segment in a non-actuated state, according to one embodiment;

FIG. 4B is a cross-sectional view of the device of FIG. 4A in an actuated state;

FIG. 5A is a cross-sectional view of an arrangement suitable for actuating a tissue testing device, according to one embodiment;

FIG. 5B is a cross-sectional view of an arrangement suitable for actuating a tissue testing device, according to another embodiment;

FIG. 5C is a cross-sectional view of an arrangement suitable for actuating a tissue testing device, according to another embodiment;

FIG. 5D is a cross-sectional view of an arrangement suitable for actuating a tissue testing device, according to another embodiment;

FIG. 5E is a cross-sectional view of an arrangement suitable for actuating a tissue testing device, according to another embodiment;

FIG. 5F is a cross-sectional view of an arrangement suitable for actuating a tissue testing device, according to another embodiment;

FIG. 5G is a cross-sectional view of an arrangement suitable for actuating a tissue testing device, according to another embodiment;

FIG. 5H is a cross-sectional view of an arrangement suitable for actuating a tissue testing device, according to another embodiment;

FIG. 6A is a cross-sectional view of an arrangement suitable for actuating a tissue testing device, according to another embodiment;

FIG. 6B is a cross-sectional view of an arrangement suitable for actuating a tissue testing device, according to another embodiment;

FIG. 6C is a cross-sectional view of an arrangement suitable for actuating a tissue testing device, according to another embodiment;

FIG. 6D is a cross-sectional view of an arrangement suitable for actuating a tissue testing device, according to another embodiment;

FIG. 6E is a cross-sectional view of an arrangement suitable for actuating a tissue testing device, according to another embodiment;

FIG. 7A is a cross-sectional view of an arrangement suitable for actuating a tissue testing device, according to another embodiment;

FIG. 7B is a cross-sectional view of an arrangement suitable for actuating a tissue testing device, according to another embodiment;

FIG. 7C is a cross-sectional view of an arrangement suitable for actuating a tissue testing device, according to another embodiment;

FIG. 8A is a cross-sectional view of an arrangement suitable for actuating a tissue testing device, according to another embodiment;

FIG. 8B is a cross-sectional view of an arrangement suitable for actuating a tissue testing device, according to another embodiment;

FIG. 8C is a cross-sectional view of an arrangement suitable for actuating a tissue testing device, according to another embodiment;

FIG. 8D is a cross-sectional view of an arrangement suitable for actuating a tissue testing device, according to another embodiment;

FIG. 8E is a cross-sectional view of an arrangement suitable for actuating a tissue testing device, according to another embodiment;

FIG. 9 is a cross-sectional view of a device for testing a tissue segment, according to one embodiment;

FIG. 10 is a perspective view of the device of FIG. 9 showing the device attached to a tissue segment and in a non-actuated state, according to one embodiment;

FIG. 11 is a top view of a tissue segment being tested by the device of FIG. 9 showing the tissue segment in a relaxed state, according to one embodiment;

FIG. 12 is a perspective view of the device of FIG. 10 showing the device in an actuated state, according to one embodiment;

FIG. 13 is a top view of the tissue segment of FIG. 11 showing the tissue segment in a stretched state, according to one embodiment; and

FIG. 14 is a flowchart illustrating a method of testing a tissue segment, according to one embodiment.

### DETAILED DESCRIPTION

The Inventors have recognized that the ability to characterize biomaterials by their mechanical properties has many uses in bioengineering from research to surgical planning. Specifically, unlike many engineering materials, such as metals, biomaterials often exhibit non-linear, anisotropic behavior and have highly variable properties that cannot always be predicted. For example, in reconstructive heart valve surgeries, biomaterials such as autologous tissue or synthetic replacements, may be implanted within a body of a subject. The function of the heart valve may be dependent on the geometry of the material (e.g., a leaflet or a patch) being implanted as well as the anisotropic biomaterial mechanical properties of the material the valve, or other structure, is made from. Therefore, it is desirable to determine the anisotropic properties of a material for use in such applications.

In view of the above, in many instances, it may be desirable to test the material properties of a tissue segment, such as a tissue segment, or other biomaterial, that is to be implanted by a clinician or other medical professional into a subject prior to forming a structure to be implanted. In particular, it may be desirable to characterize the mechanical properties of an implantable tissue segment such that a desired geometry and/or orientation, among other properties (e.g., anisotropic properties) of the tissue segment, are known. This may allow for implantation of the tissue segment to be optimized by the clinician relative to a tissue segment in which the properties are not known. In this regard, it may be desirable to test the tissue segment as the properties may vary depending on the type of tissue segments. For example, certain tissue segments may include synthetic tissue segments, patch materials, native tissue, donor tissue, or any other suitable type of implantable tissue segment. Additionally, the implantable tissue segment may be stored in varying temperatures (e.g., the tissue segment may be frozen). Thus, different implantable tissue segments may have different mechanical properties depending on the type of tissue segment used and the environmental factors to which the tissue segment is exposed, which makes it challenging for a clinician to understand how to best prepare a given tissue segment for implantation within a subject.

The inventors have recognized that certain prior art tissue testing arrangements have been employed, but that such arrangements typically require large, non-portable, and costly equipment to conduct the tissue testing. Such equipment may require, for example, high-precision force gauges and stretching devices to yield precise measurements of the tissue properties. In addition, such large and precise equipment may require time-intensive testing steps to obtain the highly precise measurements and may not be easily sterilizable following testing. Moreover, due to the impracticality of certain prior art tissue testing devices, tissue segments may often be implanted without first being tested, which can result in complications during or following the implantation of the tissue segment.

The inventors have thus recognized that benefits may be realized by providing a tissue testing device which may apply a bias to a plurality of compliant structures that are configured to be distributed around and attached to a perimeter of a tissue segment or other suitable biomaterial to be tested. These compliant structures may be configured to elastically deform under the applied bias. Thus, by providing the bias with the tissue testing device to the biomaterial along multiple separate directions, the biomaterial may exhibit responses to the bias in these different directions and a corresponding response of the tissue segment, or other biomaterial, may be observed and/or measured. The inventors have found that the response in a given direction of the biomaterial may be dependent on the magnitude of applied bias and the directional properties of the biomaterial used which may permit anisotropic material properties to be subjectively and/or objectively determined based on the observed material responses to the applied bias.

In addition to the above, the inventors have appreciated that a suitable tissue testing device may include tissue couplings configured to engage with a corresponding tissue segment, one or more actuators, and a plurality of compliant structures configured to operatively couple the actuators to the tissue couplings. The actuators may be configured to apply a displacement to at least a portion of the compliant structures which in turn applies a displacement to the tissue segment via the tissue couplings. For example, the actuators may apply a displacement to a proximal portion of the compliant structures which may result in a displacement being applied to a distal portion of the compliant structures to which the tissue couplings and tissue segment are attached. As used herein, a proximal portion of a compliant structure may refer to a portion that is spaced away from the tissue couplings and corresponding tissue segment while a distal portion of a compliant structure may refer to a portion that is directed towards and/or adjacent to the tissue couplings and corresponding tissue segment.

As will be appreciated by one of the art, the compliant structures disclosed in the various embodiments described herein may be actuated using any suitable type of actuator to in turn deform the corresponding tissue segment. For example, the one or more actuators of a device may include one or more of a pneumatic actuator, hydraulic actuator, linear actuator, electric motor, manually operated trigger or other appropriate type of actuator. An actuator may be operatively linked with one or more corresponding compliant structures by one or more of a pulley, a piston, a plunger, a rack and pinion, one or more gears, a cable, one or more linkages, a screw, a chain, and/or any other appropriate type of transmission. Thus, it should be understood that any appropriate type and/or arrangement of an actuator may be used to actuate the various disclosed embodiments of a device for testing a tissue segment or other biomaterial.

In some instances, the inventors have recognized particular benefit to a compliant system which may be configured to apply equal magnitude displacements to the compliant structures attached to the tissue segment such that the tissue segment may deform under a load applied equally to various attachment points along the tissue segment. For example, the actuator may include a linkage mechanism while the compliant structure may include springs, and the linkage mechanism may engage the springs such that the tissue couplings coupled to the tissue segment cause the tissue segment to deform outwardly following an applied force and displacement. In some embodiments, the compliant structures may thus be actuated into an expanded configuration while the tissue segment resists the deformation applied from the actuators and compliant structures. In some such embodiments, various data such as the deformations of the tissue segment and the displacements associated with the compliant structures may then be observed, recorded, and analyzed where different displacements of the separate attachments to the tissue may be used to determine properties related to the tissue segment, e.g., anisotropic properties, which can enable a clinician to more accurately characterize a given tissue segment and more optimally implant the tissue segment within a subject.

In some embodiments, each compliant structure may receive an applied force and/or displacement approximately equal in magnitude, as noted above. In other embodiments, however, each compliant structure may receive a force and/or displacement of varying magnitude. Combinations of the foregoing are also possible. For example, some of the compliant structures may receive an equal magnitude force while other compliant structures receive a force of different magnitude. Thus, the compliant structures and tissue couplings may serve to apply a certain force and/or displacement to deform the tissue segments to a greater or lesser degree in certain directions. In some cases, the applied forces and displacements may be similar for opposing compliant structures and tissue couplings engaged with the tissue segment (e.g., along the same axis). As used herein, the term “approximately equal magnitude” may refer to any suitable range of magnitudes (e.g., a percentage difference between a maximum magnitude and a minimum magnitude). This may include magnitudes having a percentage difference of greater than or equal to 10%, 12.5%, 15%, or greater. This may also include magnitudes having a percentage difference of less than or equal to 10%, 5%, 2.5%, 1%, 0% or lesser. Of course, percentage differences both greater than and less than those noted above are also contemplated as the disclosure is not so limited. Thus, the term “approximately equal magnitude displacement” may refer to any suitable magnitude range of displacements which may be applied to the compliant structures to in turn deform a corresponding tissue segment. For example, an actuator may apply an approximately equal magnitude displacement to a proximal portion of each compliant structure to which it is operatively coupled, and the displacement may in turn apply deformation to the tissue segment via the tissue couplings attached to the segment.

When the tissue testing device applies deformation to the tissue segment, data relating to the tissue segment may then be collected in any suitable manner. For example, in some embodiments, the clinician may view the tissue segment either with the naked eye, and/or a scope disposed on the device. The clinician may then make a visual judgment and/or take quantitative measurements regarding the deformation of the tissue segment to qualitatively determine compatibility and/or an appropriate way of implanting the tissue segment into a subject. Alternatively or in addition, the device may include one or more photosensitive detectors, such as a CCD imaging sensor, CMOS imaging sensor, other types of imaging devices, and/or any other device configured to capture images and/or video of the deformation of the tissue segment. In some embodiments, the photosensitive detectors may image the tissue couplings and the compliant structures of the tissue testing device. The clinician may then visually inspect the photo and/or video to make a qualitative determination regarding compatibility and/or an appropriate means of implanting the tissue segment into the subject. Alternatively, the images may be analyzed by one or more associated processors to determine one or more properties of the tissue segment in two or more directions as detailed further below. In some embodiments, the tissue testing arrangement may include one or more registration marks associated with the compliant structures of the tissue testing device such that data (e.g., deformation) of the tissue segment may be easily collected and quantified. The registration marks may be located on any of the compliant structures, the actuators, the tissue segment, and/or the tissue couplings as the disclosure is not so limited. For example, registration marks may be provided on opposing portions of the tissue segment and deformation of the tissue segment may be quantified by calculating a change in the distance between the registration marks once the tissue segment is deformed.

While the embodiments of an anisotropic material tester disclosed herein are primarily described in reference to a tissue testing device, the device may be employed for use with any suitable material segments including, but not limited to biomaterial segments (e.g., tissue segments) and synthetic materials (e.g., textile materials, composite materials, etc), and/or any other compliant planar material segment that is capable of being tested with the disclosed devices. In some embodiments, a suitable biomaterial segment may include, but is not limited to thick patch pulmonary homograft, thin patch pulmonary homograft, autologous pericardium, bovine pericardium, synthetic patches (e.g., Dacron™, GORE-TEX™, etc), aortic homograft, CorMatrix™, Integra™, femoral vein, or any other suitable synthetic, native, or donor tissue segments as the disclosure is not so limited. In some embodiments, the material segments may be of any suitable shape, size, or other characteristic as the disclosure is not so limited. For example, the material segments may be substantially circular, square, rectangular, triangular, or of any other suitable geometric profile as needed for a given application. For the sake of clarity, the embodiments disclosed herein are described primarily in reference for use with a tissue segment, but any of the disclosed embodiments herein may be used to test any suitable material segments including the above noted materials. The testing of these material segments may be done in-vivo and/or ex-vivo as the disclosure is not so limited.

As used herein, a “compliant structure” may refer to a structure that is flexible and able to achieve force and motion transmission though elastic body deformation. Any suitable type of compliant structures may be employed in the tissue testing device described herein including, but not limited to springs, compliant arms, elastomers, and/or any other type of elastic structure capable of elastically deforming between a biased and unbiased state to apply a measurable amount of force to an associated tissue segment or other biomaterial. The springs may be of any suitable type including, for example, helical springs, leaf springs, disk springs, and gas springs (e.g., bladder-type accumulators). In some embodiments, multiple types of compliant structures may be used, for example, both springs and compliant arms which may be operatively coupled to one another. In other embodiments, however, only a single type of compliant structure may be used such as springs which are configured to engage rigid arms to deform a corresponding tissue segment.

In some embodiments, the actuators according to embodiments disclosed herein can apply a force and a corresponding displacement to the compliant structures of any suitable magnitude as the disclosure is not so limited. For example, a suitable applied force may have a magnitude greater than or equal to 1 N, 2 N, 3 N, 4 N, or greater. In another example, a suitable applied force may have a magnitude lesser than or equal to 5 N, 4 N, 3 N, 2 N, or lesser. Combinations of the foregoing are also contemplated including forces between or equal to 1 N and 5 N. Of course, forces both greater and lesser than those noted above are also contemplated as the disclosure is not so limited. In some embodiments, the force that is applied to the tissue segment by the actuators and compliant structures may be less than a plastic deformation threshold of the tissue segment and the compliant structure such that the tissue segment and compliant structure may return to their original shapes following deformation. In other embodiments, however, the force that is applied to the tissue segment may cause the tissue segment to be plastically deformed such that it will not return to its original shape following deformation.

As will be appreciated by one of skill in the art, the tissue couplings may be constructed and arranged such that they are coupled to both the compliant structures and the tissue segment. For example, the tissue couplings may include pins, clamps, tines, teeth, brackets, sutures, hooks or any other suitable coupling that may be used to engage the tissue couplings with the tissue segment. Thus, in some embodiments, the tissue couplings may engage with the tissue segment by non-destructively attaching to the segment (e.g., via the clamps). While these arrangements are disclosed, the tissue couplings may be secured to the tissue segment in any suitable fashion (e.g., via a friction fit) as the disclosure is not so limited. In some embodiments, the tissue couplings may be arranged around a perimeter of the tissue segment at regular or irregular intervals. The tissue couplings may also be radially spaced from the perimeter of the tissue segment at any amount as the disclosure is not so limited. For example, the tissue segment may be substantially circular, and a plurality of tissue couplings (e.g., 12 couplings) may be equally spaced from one another along the perimeter of the tissue segment such that a displacement may then be applied to each of the couplings and in turn the tissue segment.

Within a tissue testing device according to the embodiments disclosed herein, any suitable number of actuators, compliant structures, and/or tissue couplings may be used. In some embodiments, the device may include 1, 2, 3, 4, or more actuators. In some embodiments, the device may include 1, 2, 3, 4, 5, 6, 7, 8, 9, 10, 11, 12 or more compliant structures as the disclosure is not so limited. In addition, in some embodiments, the device may include 1, 2, 3, 4, 5, 6, 7, 8, 9, 10, 11, 12 or more tissue couplings configured to engage with a corresponding tissue segment. For example, a tissue testing device may include a single actuator as well as 12 compliant structures (e.g., compliant arms) and 12 tissue couplings, where each compliant structure is coupled with a corresponding tissue coupling such that the actuator is operatively coupled with the tissue couplings. The singular actuator may apply a force to the compliant structures and in turn the tissue couplings to deform a corresponding tissue segment. While such an example is disclosed, any suitable number of actuators, compliant structures, and/or tissue couplings may be used and operated in any suitable fashion (e.g., there may be an actuator for each compliant structure and tissue coupling, there may be a greater or lesser number of compliant structures relative to tissue couplings, etc).

The actuators, compliant structures, and/or tissue couplings may also be constructed of any suitable material or materials. In some embodiments, these components may be formed from a metal such as iron, steel (e.g., stainless and/or spring steel), titanium, aluminum, and/or any other suitable metal. Embodiments where these components are made from non-metals are also contemplated including, but not limited to one or more plastics such as High-Density Polyethylene (HDPE), Polyvinyl Chloride (PVC), Polypropylene, carbon fiber reinforced plastics, and/or any other suitable non-metal. In some embodiments, any of these components may be formed of a material that may be suitable to be sterilized for single-use or repeated use.

In some embodiments, the tissue testing device may be configured for use in a handheld system. The inventors have recognized that providing a tissue testing device in a portable, handheld format may serve to provide benefits, e.g., to allow a clinician to test a tissue segment immediately prior to implantation in a subject. However, without wishing to be bound by theory, the embodiments disclosed herein may not be provided in a handheld format, but rather the device can be of any suitable size depending on the application as the disclosure is not so limited.

The inventors have recognized that the embodiments of a tissue testing device disclosed herein may provide a variety of benefits when implemented for use in characterizing the properties of a corresponding tissue segment. Such benefits include that the device may be sterilizable, portable, and/or disposable (e.g., a single-use or a multi-use testing device). The tissue testing device may also provide the ability to conduct in-vivo and ex-vivo tissue testing with a sufficient degree of accuracy while also remaining less expensive than certain prior art large-scale tissue testing arrangements which require expensive equipment as a high degree of precision is necessary. In particular, in some cases, the inventors have recognized that a high precision tissue testing device may not be needed during certain tissue implantation procedures as it may be more important to quantify approximate optimal geometries and orientations of the tissue segment in a timely and cost-effective fashion. Thus, the tissue testing device disclosed herein may allow for rapid characterization of various properties of the tissue including, but not limited to strain, stress, applied forces, principal material direction, and other suitable properties. Such characterization for a given tissue segment may allow a clinician to evaluate how to optimally implant the tissue segment into a subject to effectuate a repair.

The inventors have also recognized that the embodiments of a tissue testing device disclosed herein may be used in a variety of suitable applications as the disclosure is not so limited. In some embodiments, a tissue testing device according to embodiments disclosed herein may be employed for use in in-vivo testing of a subject prior to harvesting a select tissue segment. In other embodiments, the tissue testing device may be employed for use in ex-vivo testing, e.g., in an operating room for the testing of autologous tissue segments obtained from the patient. In other embodiments, the tissue testing device may be employed to characterize the properties of tissue segments obtained from sources other than the subject, e.g., for the processing and preparation of homografts.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

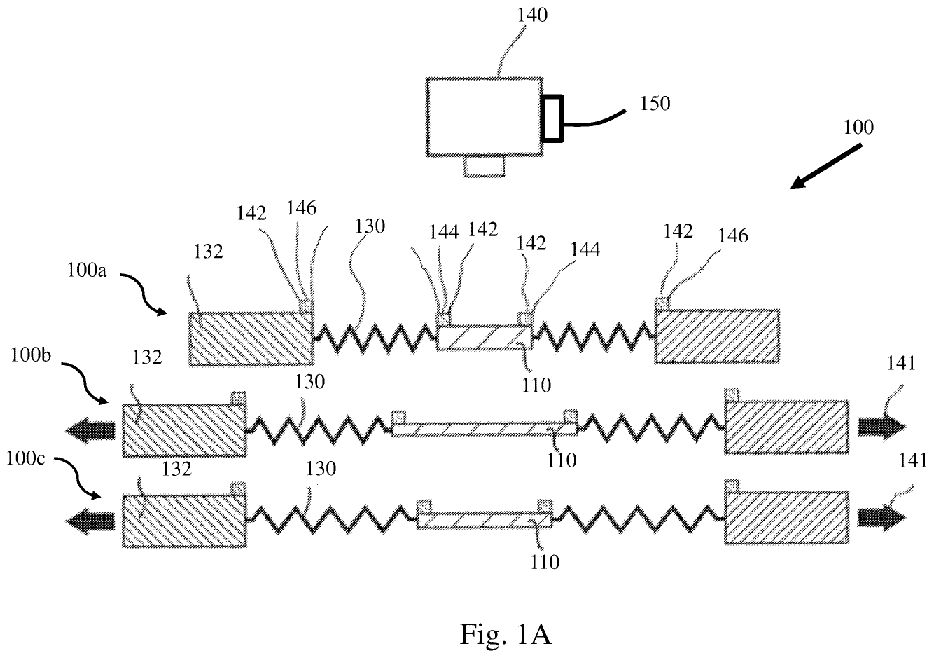

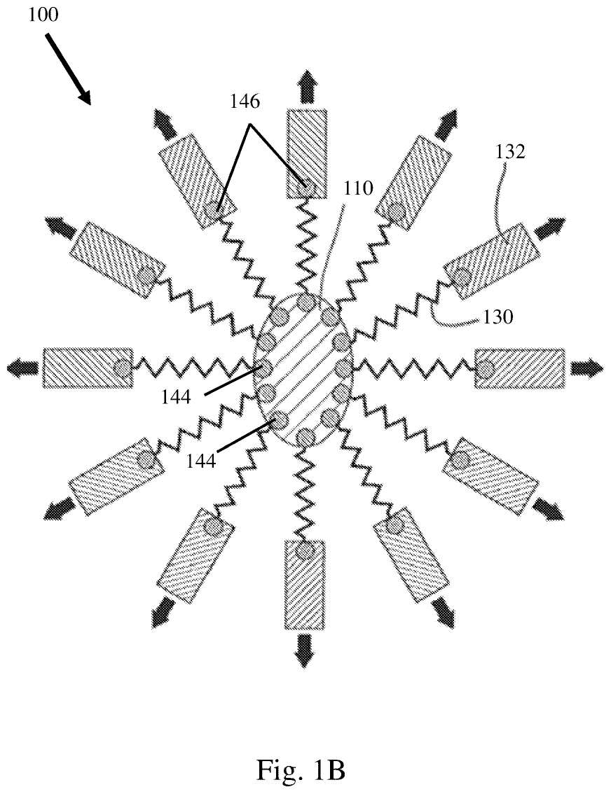

FIG. 1A shows a cross-sectional view of a single axis of a tissue testing device 100 during different stages of deformation. In FIG. 1A, stage 100a denotes an undeformed state of the tissue segment 110 while stages 100b and 100c denote stages having different magnitudes of force and displacement applied to the tissue segment 110. The tissue testing device 100 may include actuators 132 and a plurality of compliant structures in the form of springs 130. The tissue testing device 100 may engage with the tissue segment 110. In particular, the springs 130 may operatively couple the actuators 132 to the tissue segment 110 via one or more tissue couplings (not shown) engaged with both the springs 130 and the tissue segment 110. In some embodiments, a photosensitive detector 140 may be located with a desired position and orientation (e.g., above) relative to the tissue segment 110 such that the tissue segment, and optionally one or more portions of the tissue testing device, may be located within a field of view of the photosensitive detector. The photosensitive detector 140 may interface with one or more processors 150 that are configured to analyze data associated with the photos and/or videos collected by the photosensitive detector.

In some embodiments, the plurality of compliant structures may be configured to operatively couple one or more actuators with a plurality of tissue couplings that are configured to engage a corresponding tissue segment at a plurality of attachment points, as described above. Upon actuation of the actuators, the compliant structures and tissue couplings may deform the tissue segment. In some embodiments, the actuators may apply a displacement to a proximal portion of each of the compliant structures such that a portion (e.g., a distal portion) of the compliant structures, and in turn the tissue segment, is displaced radially outwards. In some embodiments, the proximal portions of the compliant structures may be translated and/or rotated to permit displacement of the compliant structures and deformation of the tissue segment. The compliant structures may also be configured to elastically deform such that the compliant structures may return to their original shape following the removal of an applied force from the one or more actuators. In some embodiments, an amount of displacement of the tissue segment as well as each tissue coupling and corresponding portion of the compliant structures to which the couplings are attached may be dependent on one or more anisotropic properties of the tissue segment.

A set of registration marks 142 may be positioned on the tissue segment 110, the tissue couplings, compliant structures 130, and/or the actuator 132 to provide points of reference that may be used to calculate deformation of the tissue segment 110 from the data recorded and processed by the photosensitive detector 140 and processor 150, respectively. The set of registration marks 142 may include interior markers 144 and exterior markers 146. In some embodiments, the exterior markers 146 may be located on a rigid portion of the tissue testing device 100 that is configured to remain stationary while the interior markers 144 may be located on a movable portion of the arrangement. For example, the interior markers 144 and the exterior markers 146 may be located on the tissue segment 110 and actuators 132, respectively, such that the location of the interior markers 144 may move as the tissue segment 110 is deformed. In some embodiments, both the interior markers 144 and exterior markers 146 may be located on movable portions of the tissue testing arrangement as the disclosure is not so limited. For example, the interior markers 144 and the exterior markers 146 may be located on the tissue segment 110 and actuators 132, respectively, and the location of both the interior and exterior markers may move as the tissue segment 110 is deformed (e.g., the actuators may move relative to the tissue segment as well). While the above example of registration marks are shown, registration marks may be located on any of the tissue segment, actuators, compliant structures, and/or tissue couplings as the disclosure is not so limited.

While qualitative observation and/or analysis may be appropriate in some applications, and other embodiments, a clinician may wish to perform a quantitative analysis on the deformation of the tissue segment as measured using the deformation captured by employing a photosensitive detector, e.g. a camera, or other appropriate sensor of the device. Accordingly, in some instances, the tissue testing device may be configured to interface with one or more processors (e.g., either on board the device or external to the device). In turn, the processor may be configured to quantify one or more parameters of the tissue segment based at least in part of the photos and/or videos collected by the camera of the device. By analyzing such data, the processor may assist a clinician in determining compatibility and/or an appropriate means of implanting the tissue segment into a subject. The processor may analyze any suitable parameters of the deformation of the tissue segment including directional and/or absolute elongation of the tissue segment, force applied to the tissue segment, and/or attachment location of the compliant structures via the tissue couplings relative to the tissue segment. As will be appreciated by one of skill in the art, the processor may analyze any suitable parameters of the deformation, including those not discussed herein, depending on the application as the disclosure is not limited in this regard.

To facilitate the acquisition of data, the processor may be operatively coupled (either wired or wirelessly) to the one or more sensors disposed on the device such as, for example, a photosensitive detector. Alternative or in addition to the images and/or video collected by the camera, any suitable sensor may serve to collect data regarding one or more parameters of the deformation of the tissue segment (e.g., directional and/or absolute elongation of the tissue segment, force applied to the tissue segment, attachment location of the compliant structures relative to the tissue segment, etc.). In turn the sensors may relay the data to the processor to analyze the data, for example, as described herein. In some embodiments, the data from certain sensors may be used to confirm the data collected by the camera, while in other embodiments the camera and the sensors may collect complementary data. As will be appreciated by one of skill in the art, the sensors may collect any suitable type of data, depending on the application, as the disclosure is not so limited in this regard. Appropriate types of sensors that may be used may include, but are not limited to, photosensitive detectors, strain gauges, force gauges, displacement sensors, and/or any other appropriate type of sensor as the disclosure is not so limited.

As will be appreciated by one of skill in the art, embodiments of a device for testing a tissue segment may include both a photosensitive detector and one or more other sensors, only a photosensitive detector, only one or more sensors of a different type (e.g., strain gauges or any other suitable sensor noted above), or neither a photosensitive detector nor any other sensors (e.g. manual observation). Of course, any suitable configuration of photosensitive detectors and/or other sensors may be employed, depending on the application as the disclosure is not so limited in this regard.

In some embodiments, a video recording may be taken over a duration of the testing of the tissue segment 110. In some such embodiments, a calibration image may first be taken to calculate a conversion between each of the pixels within the recording to a distance between the registration marks. The registration marks may take any suitable form including, for example, a bullseye design having a dot at the center of the registration mark to signify the center point. To measure deformation, the distance between the interior markers 144 on the tissue segment 110 may first be determined using the known conversion between the pixels and relative distances. Other parameters such as the spring stiffness and tissue segment thickness may also be calculated prior to deforming the segment. Next, the actuators 132 may apply a predetermined displacement via the compliant structures (springs 130) to the tissue segment 110 to deform the tissue segment 110 radially outward. The distance between interior markers 144 and exterior markers 146 may be measured. Using this distance, the known stiffness of the spring, and the original length of the spring, the force on the tissue segment 110 may be calculated along a given axis. The above process may be repeated for each axis of the tissue testing device 100 to calculate the force and displacement of the tissue segment 110 along each axis. As used herein, an “axis” of the tissue testing device refers to an axis along which the tissue testing device may apply a colinear displacement to two portions of the corresponding tissue segment. For example, a single axis of the tissue testing device may include first and second compliant structures as well as first and second tissue couplings attachable to the tissue segment. These compliant structures and tissue couplings may be colinearly aligned with one another such that a displacement may be applied to opposing portions of the tissue segment. In such a configuration, one or more actuators may be configured to apply an approximately equal magnitude displacement to the first and second compliant structures, and the compliant structures may be configured to apply an approximately equal magnitude displacement to deform the tissue segment via the tissue couplings. The processor 150 may also perform all of the above calculations by analyzing the location of the pixels over the duration of the frames of the video recording. For example, following the calibration image, the processor 150 may analyze the distances of the registration marks 142 via the pixels over a set number of frames (e.g., 50 frames). The processor 150 may use the final frame of the number of frames to calculate the overall deformation along a given axis of the tissue testing device 100.

In some embodiments, post-processing techniques may be employed to calculate various parameters of the tissue segment from data collected by the photosensitive detector and/or sensors according to embodiments disclosed herein. In particular, once testing has been completed for a tissue segment and the corresponding deformation of the segment has been recorded, parameters including, but not limited to strain, stress, force, and thickness of the tissue segment may be calculated.

To calculate strain values, a single axis of the tissue testing device is considered and the location of registration marks on the tissue testing device and/or tissue segment are first identified. As used herein, interior registration marks refers to markers located at or near the attachment points of the tissue segment while exterior registration marks refers to markers located further away from the tissue segment (e.g., on the actuator). The relative distance between opposing interior registration marks within an axis for each frame during deformation is calculated, and the tissue length post-deformation along a single axis is computed by subtracting an offset of the registration marks from this relative distance. This offset is the distance between the attachment point on the tissue segment and the location of a registration mark on the tissue testing device. To account for variability in the starting distance of the registration marks and the mounting of the tissue segment, an average distance between the registration marks is calculated for a given number of frames (e.g., 50 frames over which the deformation is recorded). To calculate displacement of the tissue segment, the tissue starting length is subtracted from the tissue length for a given frame. Subsequently, strain of the tissue segment may then be calculated for a given frame by dividing the displacement of the tissue by the starting tissue length.

To calculate displacement of the compliant structures, a single axis of the tissue testing device is considered and the location of the registration marks on the tissue testing device and/or tissue segment are first identified. A relative distance between interior and exterior registration marks on each side of the axis is then calculated. To account for variability in the starting distance of the registration marks, an average different between the interior and exterior marks is calculated for a given number of frames (e.g., 50 frames). To calculate displacement of the compliant structures, the starting distance is subtracted from the distance between the interior and exterior marks for each frame, and the total displacement for a given axis is calculated by adding the displacement for each side of the axis.

To calculate the applied force, the total displacement of the compliant structures is multiplied by the spring constant of the compliant structure, and then divided by a factor of two to determine the applied force along a given axis.

The thickness of the tissue segment following deformation may also be calculated. The area of the tissue segment during each frame may be recorded using image tracking and can be calculated by approximating the tissue segment as a polygon of known area. Using the known tissue thickness prior to testing, the updated tissue thickness can be calculated by multiplying the starting area by the starting thickness of the tissue segment, and then by dividing by the area of the tissue segment following deformation at a given frame. While the parameters disclosed above are calculated in reference to a single axis, these calculation techniques may be propagated along each axis in which the tissue testing device applies deformation to the tissue segment as the disclosure is not so limited.

Total force on a cross-sectional area of the tissue segment may then be calculated multiplying the magnitude of each of the applied force values by the cosine of their angle relative to a perpendicular axis, and then by calculating the summation of these values. The overall stress may then be calculated by dividing the total force summation by the cross-sectional area at a specific frame for a given number of frames of the image tracking, where the area is defined by the specific width and thickness of the tissue at the frame.

The values of stress and strain for a given test on a tissue segment can then be plotted in a stress-strain curve. For example, each frame over a given number of frames (e.g., 50 frames) may have calculated stress and strain values using the techniques described above, and each of these values may be plotted to form the curve. The slope of the stress-strain curve may then be used to calculate Young's Modulus values, which can provide a determination of which axes of a given tissue segment are the most or least stretched. This information can serve to help a clinician in optimizing the implantation of a tissue segment in a subject because the clinician would have an understanding as to which portions of the tissue segment will stretch to a greater degree, and thus allow the clinician to determine the optimal orientation to implant the tissue segment.

In addition or alternately, the tissue testing device 100 may include any suitable position sensors which may be located on any of the tissue segment, the compliant structures, the tissue couplings, and/or the actuators. In some embodiments, a suitable position sensor includes, but is not limited to hall effect sensors, strain gauges, linear variable differential transformer (LVTD) sensors, or any other suitable sensor type. In some embodiments, the sensors may be configured to track the displacement of the compliant structures and/or tissue couplings such that deformation of the tissue segment may be calculated. In some embodiments, the sensors may be used in combination with the photosensitive detector 140 which is configured to image the tissue testing device 100 and/or tissue segment 110 according to embodiments disclosed herein. The sensors may interface with the processor 150, which may be integrated with or separated from the photosensitive detector 140 to analyze and calculate the relative position of the sensors. Whether a photosensitive detector and/or one or more position sensors are used to quantify the deformation, the processor may quantify and output force and/or displacement data for a given tissue segment to a clinician so that they can optimize implantation of the tissue segment.

FIG. 1B shows a top view of the device of FIG. 1A where multiple axes of the tissue testing 100 can be seen. As can be seen in FIG. 1B, the actuators 132 may actuate the compliant structures (springs 130) with a substantially equal magnitude of displacement applied to a proximal portion of the compliant structures to deform the tissue segment 110. In this embodiment, six axes having twelve compliant structures and attachment points to the tissue segment are shown. However, any suitable number of actuators, compliant structures, and/or tissue couplings may be employed as the disclose is not so limited. As the photosensitive detector 140 and processor 150 image and record deformation of the tissue segment 110, the force and deformation values may be calculated and the principal material directions of the tissue segment 110 may be calculated to better inform a clinician as to how the tissue segment 110 may be optimally implanted within a subject

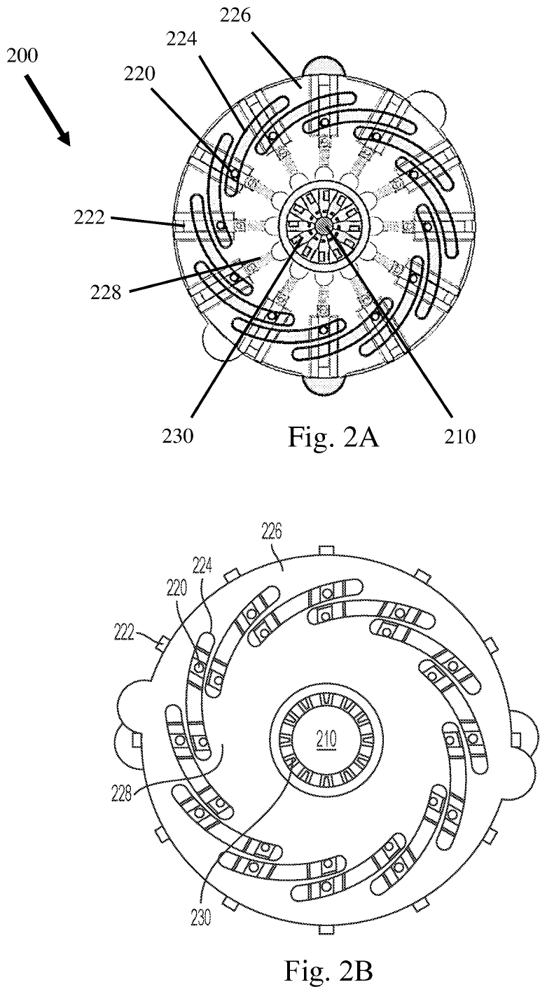

FIG. 2A shows an embodiment of a tissue testing device 200 in a non-actuated state. The tissue testing device 200 includes a rotatable cam plate 226 having a plurality of cam profiles formed therein and a plurality of cams in the form of pins 220. The pins 220 are engaged with shuttles 222 and may be configured to slide along curved grooves 224 of the cam plate 226. Each of the shuttles 222 may be attached to a spring 228 which may then be engaged with a tissue segment 210 via tissue couplings 230. The shuttles 222 may be configured to be driven in an outward direction in response to movement of the pins 220 along the curved grooves 224 such that movement of the shuttles 222 applies displacement to the respective springs 228 to which they are attached. Each of the springs 228, the shuttles 222, the pins 220, and the curved grooves 224 may be distributed around a perimeter of a portion of the tissue testing device 200 which engages with the tissue segment 210 via the tissue couplings 230. To initiate testing and deformation of the tissue segment 210, the cam plate 226 may be rotated relative to a body of the tissue testing device 200, which moves the shuttles 222 at a set distance from their original position. Since the pins 220 are engaged with both the shuttles 222 and to the proximal portions of springs 228, movement of the shuttles via rotation of the rotatable cam plate 226 applies forces to the springs 228 in an outwards radial direction and thereby causes deformation to the tissue segment 210 via movement of the tissue couplings 230. An actuated state of the tissue testing device is shown in FIG. 2B. The distance at which the shuttles 222 are moved, and in turn the amount of deformation applied to the tissue segment 210, may be dependent on the amount of rotation applied to the cam plate 226. In some embodiments, the rotation of the cam plate 226 relative to the springs 228 may apply an approximately equal magnitude displacement to the proximal portion of each of springs 228 via the shuttles 222 to deform the tissue segment 210. In some embodiments, the cam profiles of the rotatable cam plate 226 may be of a suitable shape and be located at a suitable position to provide the approximately equal magnitude displacement to the shuttles 222. For example, the cam profiles may each have a curved shape of approximately equal size to provide an equal displacement when the cam plate 226 is rotated. The cam profiles may also be positioned at an approximately equal distance relative to the corresponding tissue segment, which may permit an approximately equal displacement to be applied from the given starting position of the shuttles 222 and springs 228. While FIGS. 2A and 2B depict springs 228, any suitable compliant structure may be used as the disclosure is not so limited. Moreover, other suitable cams may be used other than pins 220 as the disclosure is not so limited.

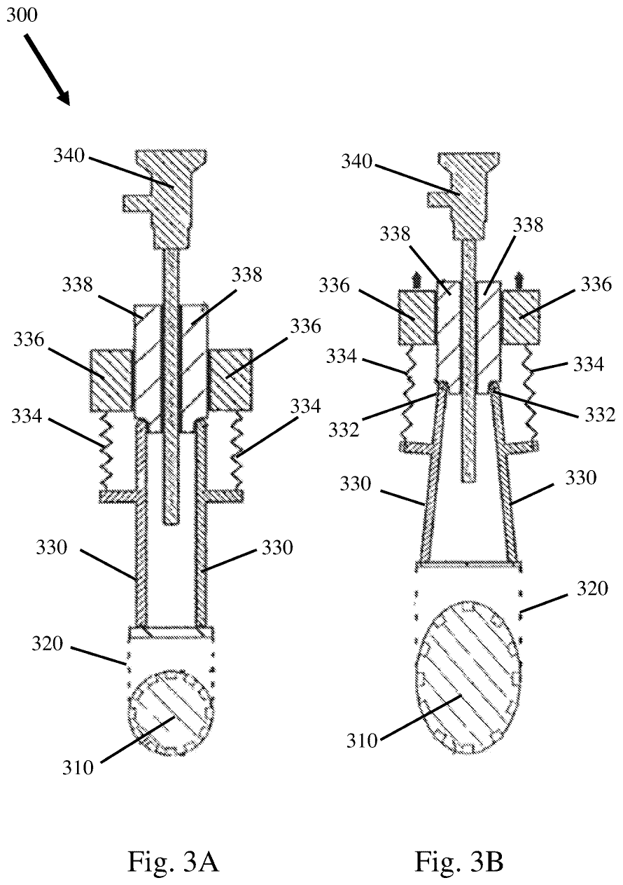

FIG. 3A shows a cross-sectional view of an embodiment of a tissue testing device 300 in a non-actuated state where the device is engageable with a tissue segment 310 along an axis 320. The tissue testing device 300 includes actuators 336, compliant structures in the forms of springs 334, and rigid arms 330 which may be coupled to the tissue segment 310. The springs 334 may serve to operatively couple the actuators 336 to the rigid arms 330 such that displacement applied to proximal portions of the springs 334 via the actuators 336 in turn applies deformation to the tissue segment 310. FIG. 3B shows the embodiment of FIG. 3A in an actuated state where the actuators 336 apply displacement to the springs 334, thus causing the rigid arms 330 to rotate along pivot points 332 to displace distal portions of the rigid arms 330 radially outward. This may cause a corresponding deformation in the tissue segment 310 since the distal portions of the rigid arms 330 are attached to the segment. In particular, FIG. 3B shows that the tissue segment 310 experiences anisotropic deformation following the displacement of the rigid arms 330 such that the tissue segment 310 is enlarged relative to the tissue segment 310 of FIG. 3A. In the embodiments of FIGS. 3A and 3B, a photosensitive detector 340 may be included which may extend down a central axis of the device body 338 to view the deformation of the tissue segment 310. In addition or alternately to the use of a photosensitive detector, a scope may be used to allow a clinician to manually view the deformation as the disclosure is not so limited. Moreover, while only two rigid arms 330 and two springs 334 are shown in the cross-sectional views of FIGS. 3A and 3B, any suitable number of springs and rigid arms may be employed in the tissue testing device as the disclosure is not so limited.

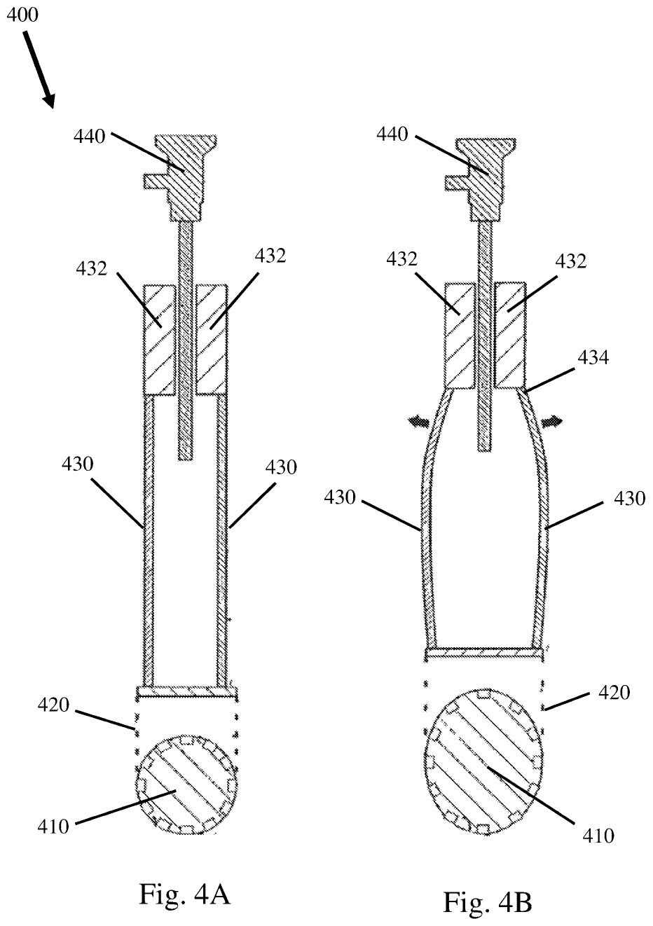

FIG. 4A shows a cross-sectional view of another embodiment of a tissue testing device 400 in a non-actuated state where the device is engageable with a tissue segment 410 along an axis 420. The tissue testing device 400 includes compliant arms 430. The compliant arms 430 may be attached at a proximal end to a device body 432 and at a distal end to the tissue segment 410 via tissue couplings as disclosed herein. The compliant arms 430 may be constructed and arranged to flex outwardly when a displacement is applied to the proximal portions of the compliant arms 430, thereby applying deformation to the tissue segment 410. In some embodiments, one or more actuators may be engaged with the compliant arms 430 to apply the displacement to the arms. An endoscope 440 may be included which may extend down a central axis of the device body 432 to view the deformation of the tissue segment 410. In addition or alternately to the use of an endoscope, a photosensitive detector and may be used to record the deformation of the tissue segment as the disclosure is not so limited. Moreover, while only two compliant arms 430 are shown in the cross-sectional views of FIGS. 4A and 4B, any suitable plurality of complaint arms may be employed in the tissue testing device as the disclosure is not so limited.

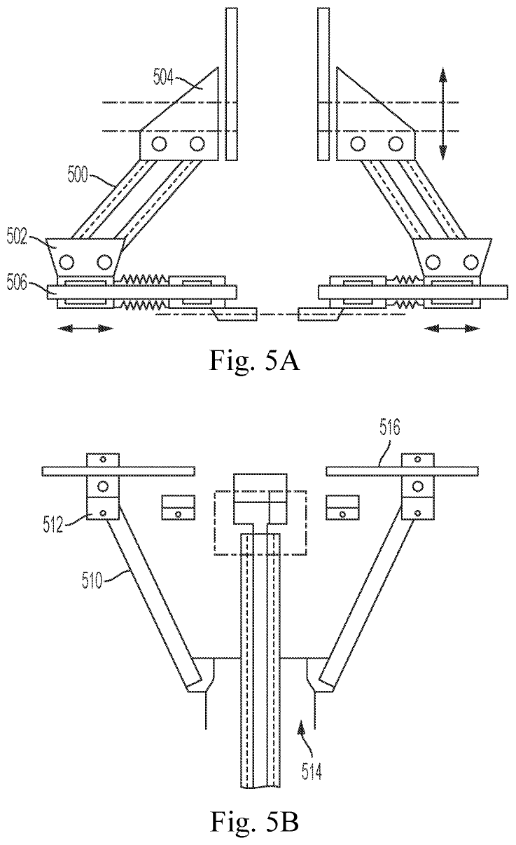

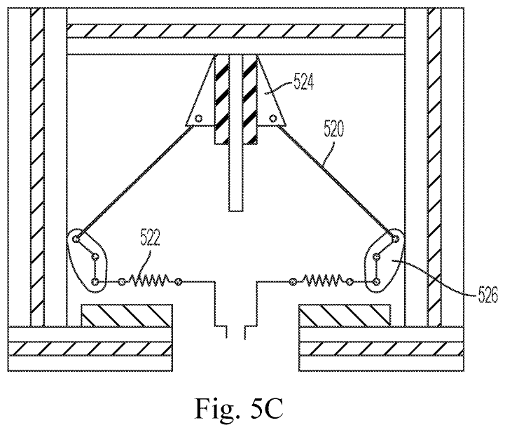

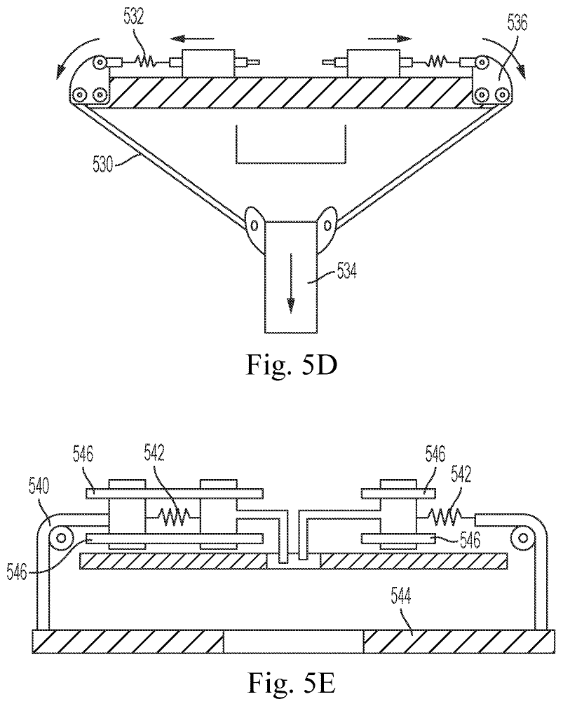

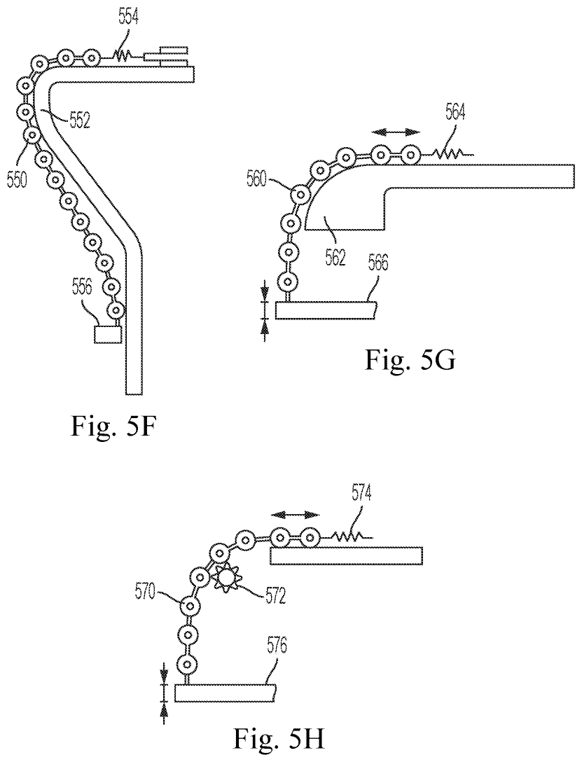

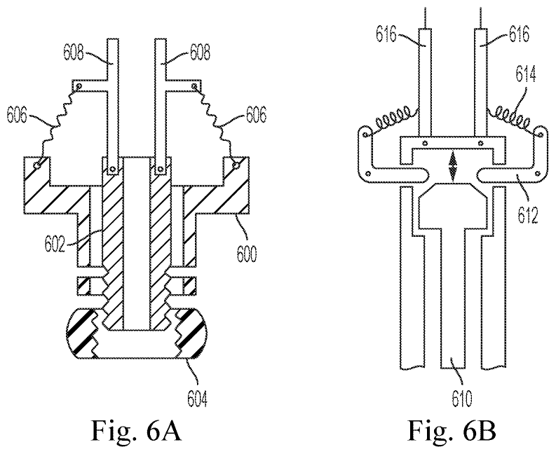

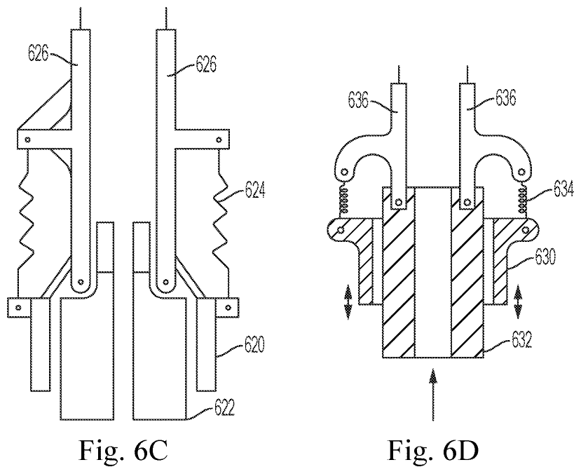

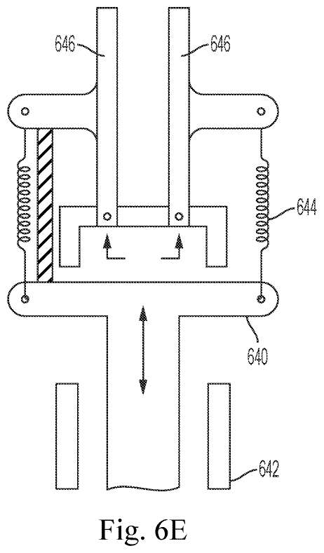

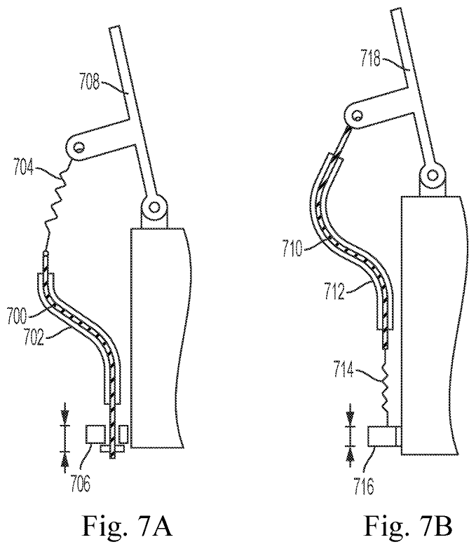

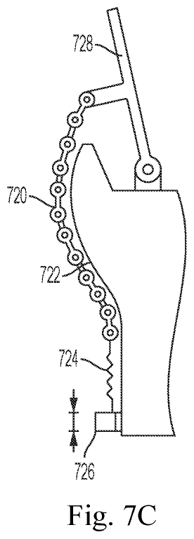

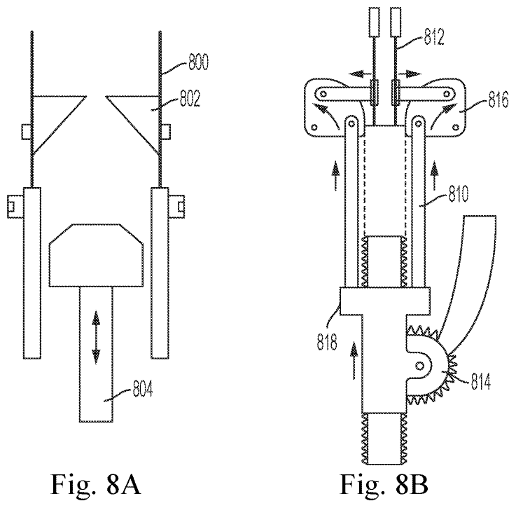

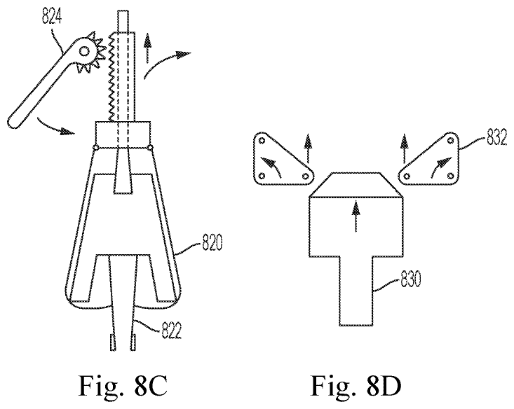

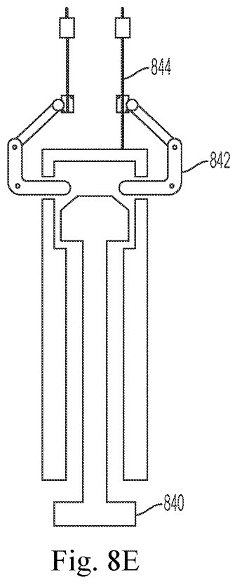

FIGS. 5A-H, FIGS. 6A-E, FIGS. 7A-C, and FIGS. 8A-E show a plurality of different arrangements of an actuator suitable for actuating a tissue testing device. While these figures show a single axis of the tissue testing device, such techniques may be duplicated for any suitable number of axes in a tissue testing device. Moreover, such actuation techniques may be configured for use with any of the compliant structures and/or tissue couplings disclosed herein as the disclosure is not so limited.

FIG. 5A shows an embodiment in which a series of linkages 500 may move a plurality of shuttles 502 a prescribed distance. In this embodiment, the linkages 500 may be attached to a hub body 504 above the device, and the hub body 504 may be operatively coupled to the plurality of shuttles 502 via the one or more linkages 500 associated with each of the shuttles such that the hub body 504 may be controlled to move the shuttles 502 the prescribed distance. The shuttles 502 may be constrained on one or more linear rails 506 such that vertical movement of the hub body 502 may move the shuttles 502, as well as the proximal portions of the springs to which the shuttles are connected, radially between an initial configuration and an actuated configuration.

FIG. 5B shows another embodiment similar to that of FIG. 5A in which a series of linkages 510 may move a plurality of shuttles 512 a prescribed distance. In this embodiment, the linkages 510 may be attached to a hub body 514 below the device, and the hub body 514 may be operatively coupled to the plurality of shuttles 512 via the one or more linkages 510 associated with each of the shuttles such that the hub body 514 may be controlled to move the shuttles 512 the prescribed distance. The shuttles 512 may be constrained on one or more parallel linear rails 516 such that vertical movement of the hub body 514 may move the shuttles 512 radially between an initial configuration and an actuated configuration.

FIG. 5C shows an embodiment in which a series of linkages 520 may move a plurality of springs 522 a prescribed distance. In this embodiment, the linkages 520 may be attached to a hub body 524 above the device, and the hub body 524 may be operatively coupled to the springs 524 via the one or more linkages 520 and one or more Bell Crank linkages 526 associated with each of the springs 522 such that the hub body 524 may be controlled to move the springs 522 the prescribed distance. The Bell Crank linkages 526 may be used to change the axial motion of the hub body 524 to radial motion of the springs 522.

FIG. 5D shows another embodiment similar to that of FIG. 5C in which a series of linkages 530 may move a plurality of springs 532 a prescribed distance. In this embodiment, the linkages 530 may be attached to a hub body 534 below the device, and the hub body 534 may be operatively coupled to the springs 532 via the one or more linkages 530 and one or more bell Crank linkage 536 associated with each of the springs 522 such that the hub body 534 may be controlled to move the springs the prescribed distance. The Bell Crank linkages 536 may be used to change the axial motion of the hub body 534 to radial motion of the springs 532.

FIG. 5E shows an embodiment in which a series of cables 540 may move a plurality of springs 542 a prescribed distance. In this embodiment, the cables 540 may be attached to a hub body 544, and the hub body 544 may be operatively coupled to the springs 542 via the cables 540 associated with each of the springs 542 such that the hub body 544 may be controlled to move the springs 542 the prescribed distance. The cables may be constrained on two parallel linear rails 546 such that vertical movement of the hub body 544 may move the springs 542 radially between an initial configuration and an actuated configuration.

FIG. 5F shows an embodiment in which a series of chains 550 along a channel 552 may move a spring 554 a prescribed distance. In this embodiment, the chains 550 may be attached to a hub body 556, and the hub body 556 may be operatively coupled to the spring 554 via the chains 500 associated with the spring 554 such that hub body 556 may be controlled to move the springs 554 the prescribed distance. In particular, vertical movement of the hub body 556 may move the spring 554 radially between an initial configuration and an actuated configuration.

FIG. 5G shows another embodiment similar to that of FIG. 5F in which a series of chains 560 along a channel 562 may move a spring 564 a prescribed distance. In this embodiment, the chains 560 may be attached to a hub body 566, and the hub body 566 may be operatively coupled to the spring 564 via the chains 560 associated with the spring 564 such that the hub body 566 may be controlled to move the springs 564 the prescribed distance. In particular, vertical movement of the hub body 566 may move the spring 564 radially between an initial configuration and an actuated configuration.

FIG. 5H shows an embodiment in which a series of chains 570 along sprockets 572 may move the spring 574 a prescribed distance. In this embodiment, the chains 570 may be attached to a hub body 576, and the hub body 576 may be operatively coupled to the spring 574 via the chains 570 associated with the spring 574 such that the hub body 576 may be controlled to move the springs 574 the prescribed distance. In particular, vertical movement of the hub body 576 may move the spring 574 radially between an initial configuration and an actuated configuration.

FIG. 6A shows an embodiment in which a central hub body 600 may be actuated using a leadscrew 602 and nut 604 in combination with one another. In this embodiment, springs 606 may be attached to the central hub body 600 and one or more arms 608 such that as the central hub body 600 is incrementally moved in response to actuation of the lead screw 602, ends of the springs 606 may be moved a prescribed distance between an initial configuration and an actuated configuration. In turn, the movement of the springs 606 may cause the arms 608 to displace radially outward.

FIG. 6B shows an embodiment in which a plunger 610 may push on a set of linkages 612. In this embodiment, springs 614 may be attached to the linkages 612 and one or more arms 616 such that as the plunger 610 is pushed vertically to abut a proximal portion of the springs 614, the springs 614 may move a prescribed distance between an initial configuration and an actuated configuration. In turn, the movement of the springs 614 may cause the arms 616 to displace radially outward.

FIG. 6C shows an embodiment in which a central hub body 620 may be actuated by sliding along a central body 622. In this embodiment, springs 624 may be attached to the central hub body 620 and one or more arms 626 such that the springs 624 may be moved a prescribed distance set by the actuation of the central hub body 620. In particular, vertical movement of the central hub body 620 may move the springs 624, which may also cause the one or more arms 626 to displace radially outward.

FIG. 6D shows another embodiment in which a central hub body 630 may be actuated by sliding along the outside of a central body 632. In this embodiment, springs 634 may be attached to the central hub body 630 and one or more arms 636 such that the springs 634 may be moved a prescribed distance set by the actuation of the central hub body 630. In particular, vertical movement of the central hub body 630 may move the springs 634, which may also cause the one or more arms 636 to displace radially outward.

FIG. 6E shows another embodiment in which a central hub body 640 may be actuated by sliding along the inside of a central body 642. In this embodiment, springs 644 may be attached to the central hub body 640 and one or more arms 646 such that the springs 644 may be moved a prescribed distance set by the actuation of the central hub body 640. In particular, vertical movement of the central hub body 640 may move the springs 644, which may also cause the one or more arms 646 to displace radially outward.

FIG. 7A shows an embodiment in which a series of cables 700 along a channel 702 may move a spring 704 a prescribed distance. In this embodiment, the cables 700 may be attached to a central hub body 706 that may be controlled to move the springs 704 the prescribed distance. In this embodiment, the spring 704 is attached to an arm 708 which are configured to attach to a corresponding tissue segment. In particular, vertical movement of the central hub body 706 may move the cables 700 and the spring 704, which may also cause the arm 708 to displace radially outward to deform the corresponding tissue segment to which it is attached.

FIG. 7B shows an embodiment in which a series of cables 710 along a channel 712 may move a spring 714 a prescribed distance. In this embodiment, the cables 710 may be attached to a central hub body 716 that may be controlled to move the springs 714 the prescribed distance. In this embodiment, the spring 714 is attached to the central hub body 716 while the cables 710 are attached to an arm 718 which is configured to attach to a corresponding tissue segment. In particular, vertical movement of the central hub body 716 may move the spring 714 and the cables 710, which may also cause the arm 718 to displace radially outward to deform the corresponding tissue segment to which it is attached.

FIG. 7C shows an embodiment in which a series of chains 720 along a channel 722 may actuate a spring 724 a prescribed distance. In this embodiment, the chains 720 may be attached to a central hub body 726 that may be controlled to move the spring 724 the prescribed distance. In this embodiment, the spring 724 is attached to the central hub body 726 while the chains 720 are attached to an arm 728 which is configured to attach to a corresponding tissue segment. In particular, vertical movement of the central hub body 726 may move the spring 724 and the chains 720, which may also cause the arm 728 to displace radially outward to deform the corresponding tissue segment to which it is attached.

FIG. 8A shows an embodiment in which cantilever beams 800 with wedges 802 may be actuated by a central pusher 804. That is, vertical movement of the pusher 804 may cause the cantilever beams 800 to displace radially outward in response to the pusher 804 abutting the wedges 802. The wedges may be of any suitable shape such as triangular as shown in FIG. 8A.

FIG. 8B shows an embodiment in which a series of linkages 810 may be attached to cantilever beams 812. A rack and pinion handle 814 located on a central hub body 818 may be used to actuate the beams 812. In particular, actuation of the rack and pinion handle 814 may cause the central hub body 818 and the linkages 810 to move upward in an axial direction, and a Bell Crank linkage 816 may be used to change the axial motion of the central hub body 818 to radial motion such that the cantilever beams 812 are displaced radially outward.

FIG. 8C shows an embodiment in which a cable 820 may be attached to cantilever beams 822. A rack and pinion handle 824 may be used to actuate the beams 822. In particular, actuation of the rack and pinion handle 824 may cause the cable to move upward in an axial direction which causes the cantilever beams 822 to displace radially outward.

FIG. 8D shows an embodiment in which the concepts of FIGS. 8A and 8B are combined. A central pusher 830 may actuate linkages 832 to pull corresponding cantilever beams (not shown) outward. In particular, vertical movement of the central pusher 830 may abut the linkages 832 such that the linkages 832 rotate, which may cause the cantilever beams to displace radially outward.

FIG. 8E shows an embodiment in which a central pusher 840 may actuate linkages 842. These linkages 842 may be attached to cantilever beams 844 to pull them outward. In particular, the central pusher 840 may move in a vertical direction to abut the linkages 842, which may cause the linkages 842 to rotate. The rotation of the linkages may cause the cantilever beams 844 to in turn displace radially outward.

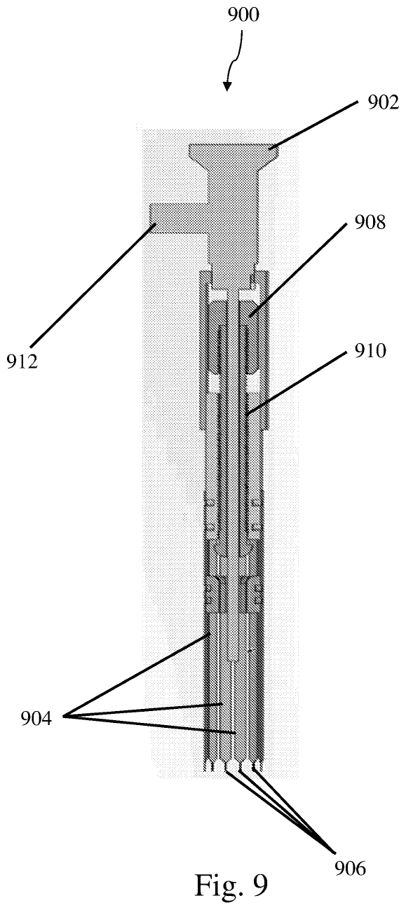

FIG. 9 shows a cross-sectional view of an embodiment of a portable, handheld tissue testing device 900 including a body 902 operatively connected to a plurality of compliant arms 904. By actuating an actuator, such as a control knob 908, a clinician may drive movement of the plurality of compliant arms 904. In particular, the actuator may apply a displacement to a proximal portion of each of the compliant arms 904 which causes displacement in a corresponding tissue segment to which the compliant arms 904 are attached via one or more tissue couplings 906. In the depicted embodiment, the tissue couplings 906 are formed as pins that are sized and shaped to engage with a surface of the tissue segment and/or to pierce the tissue segment to apply the desired forces. Thus, the tissue couplings 906 may serve to transfer force from the displacement applied to the compliant structures 904 by the actuator to the tissue segment. In some embodiments, the tissue couplings 906 may not damage or plastically deform the tissue segment such that the segment remains suitable for implantation following testing.

In some embodiments, including the embodiment illustrated in FIG. 1, the device includes features that allow a clinician to apply a consistent displacement to the proximal portions of the compliant arms to deform a tissue segment. In particular, the control knob 908 is operatively coupled to a screw 910. By loosening or tightening the control knob 908, a clinician may loosen or tighten the control knob 908 over the screw 910 to modify the actuation distance and/or displacement applied to the proximal portions of the compliant arms 904, which varies the forces applied to deform the corresponding tissue segment. For example, in some embodiments, the displacement applied to the proximal portions of the compliant arms 904, and thus the amount of force applied onto the tissue segment, may be directly related to the number of turns of the control knob 908 over the screw 910. In some embodiments, the control knob 908 may be configured to apply an approximately equal magnitude displacement to a proximal portion of each of the compliant arms 904 to deform the corresponding tissue segment.

As will be appreciated by one of skill in the art, different displacements and/or actuation distances may be set for different tissue segments as appropriate. As will be appreciated by one of skill in the art, the displacement applied to the compliant arms and the force applied on the tissue segment may be directly proportional to the actuation distance, in some embodiments.

In some embodiments, the device 900 may include features that allow a clinician to view a tissue segment when it is attached to the compliant arms 904 and/or when the tissue segment is being tested by the device 900. For example, the device 900 may include a scope 912 configured to show a clinician a view of a tissue segment. The viewing scope may provide down bore views of the tissue sample through the use of fiber optics, prisms, mirrors, and/or any other appropriate optical arrangement. Alternatively, the optical path may pass directly down a longitudinal axis of the device without the inclusion of any bends as the disclosure is not so limited. Additionally, instances in which the photosensitive detector is coupled with the scope rather than a viewing port are also contemplated.

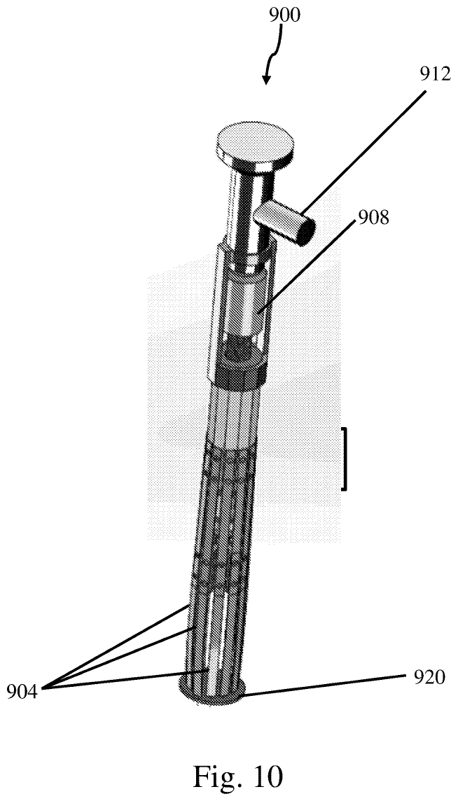

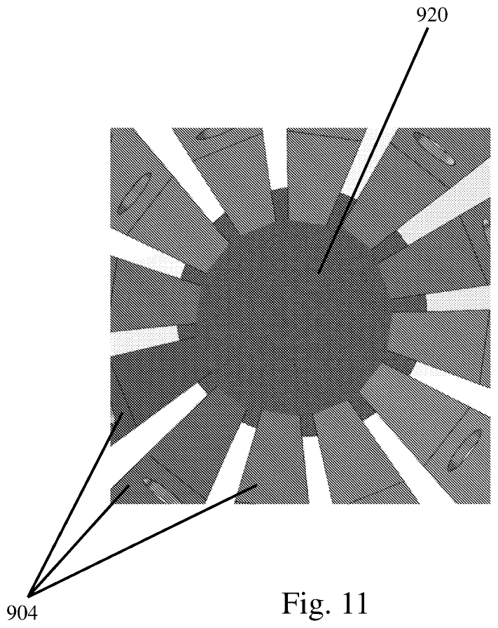

As shown in FIGS. 10-13, once a clinician attaches a tissue segment 920 to the device 900 and sets an appropriate testing force and/or actuation distance as described herein, the clinician may then use device 900 to perform deformation testing on the tissue segment 920. As shown in FIGS. 10-11, the device 900 may begin in a first, relaxed state. In some embodiments, the relaxed state may be characterized by a minimal bend or a lack of a bend in the compliant arms 904. In such a state, a clinician may test the tissue segment 920 by turning the control knob 908 over the screw 910, for example towards the tissue segment 920.

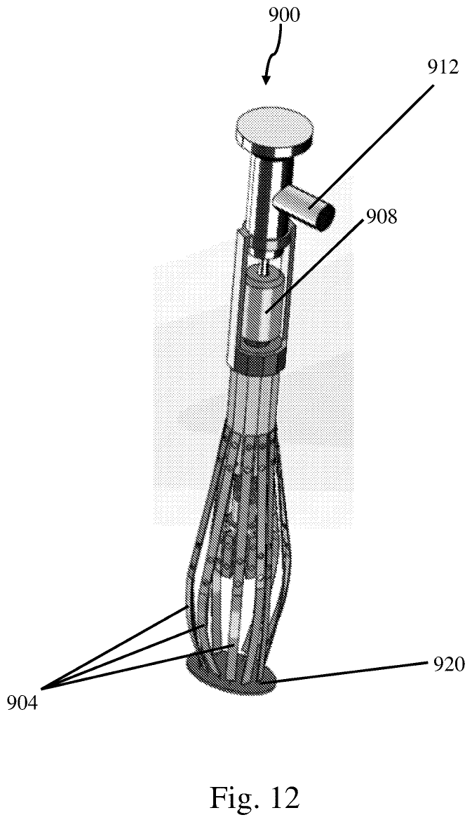

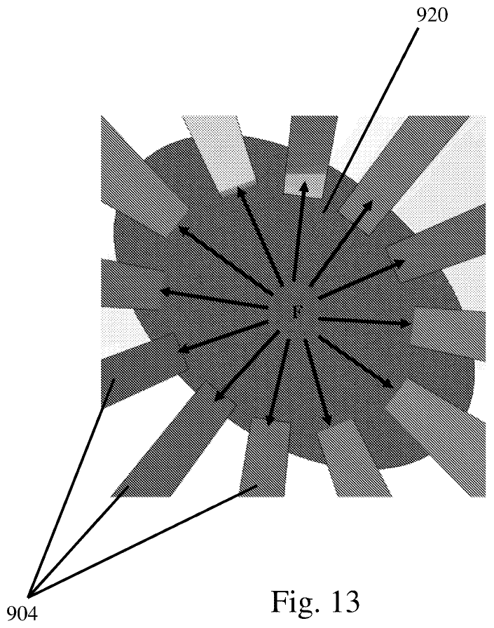

As the control knob 908 is turned towards the tissue segment 920, the device 900 transitions from the first relaxed state to a second stretched state as shown in FIGS. 12-13. The stretched state may be characterized by a bend in one or more of the compliant arms 904. In such a state, a consistent displacement may be applied to each of the compliant arms 904, which may apply an equal force F on the tissue segment 920 (e.g., as shown in FIG. 13) to deform the tissue segment 920. In some embodiments, the compliant arms 904 may be arranged such that the equal forces F emanate radially outwards from a centroid the tissue segment 920. Once the tissue segment 920 is in the stretched state, the clinician may view the deformation of the tissue segment 920 (e.g., via the scope 112 and/or any other suitable manner of viewing including those described herein). Once the clinician observes the deformation of the tissue segment 920 (either qualitatively or quantitatively as described herein), the clinician may then analyze the deformation as needed.

A device 900 may be capable of transitioning between the first relaxed state and the second stretched state in any suitable manner. Specifically, in some embodiments, including the embodiment illustrated in FIGS. 9-13, the screw 910 may serve to operatively couple the control knob 908 to the compliant arms 904. For example, as the control knob 908 is turned towards the tissue segment 920, the screw 910 may cause the compliant arms 904 to displace radially outwards. Thus, the compliant arms 904 may apply an approximately equal force on the tissue segment 920. Correspondingly, the force applied on the tissue segment 920 by the compliant arms 904 may be related to the distance that the control knob 908 travels towards the tissue segment 920 along the screw 910. Particularly, in some embodiments, the further the control knob 908 travels along the screw 910 towards the tissue segment 920, the greater degree to which the screw 910 causes the compliant arms 904 to buckle, thus causing each arm to apply a larger force on the tissue segment 920. Relatedly, the shorter the distance that the control knob 908 travels along the screw 910 towards the tissue segment 920, the lesser degree to which the screw 910 causes the compliant arms 904 to buckle, thus causing each arm to apply a smaller force on the tissue segment 920. While such an arrangement is disclosed above in reference to FIGS. 9-13, any suitable actuators, compliant structures, and/or tissue couplings may be used as disclosed herein as the disclosure is not so limited.

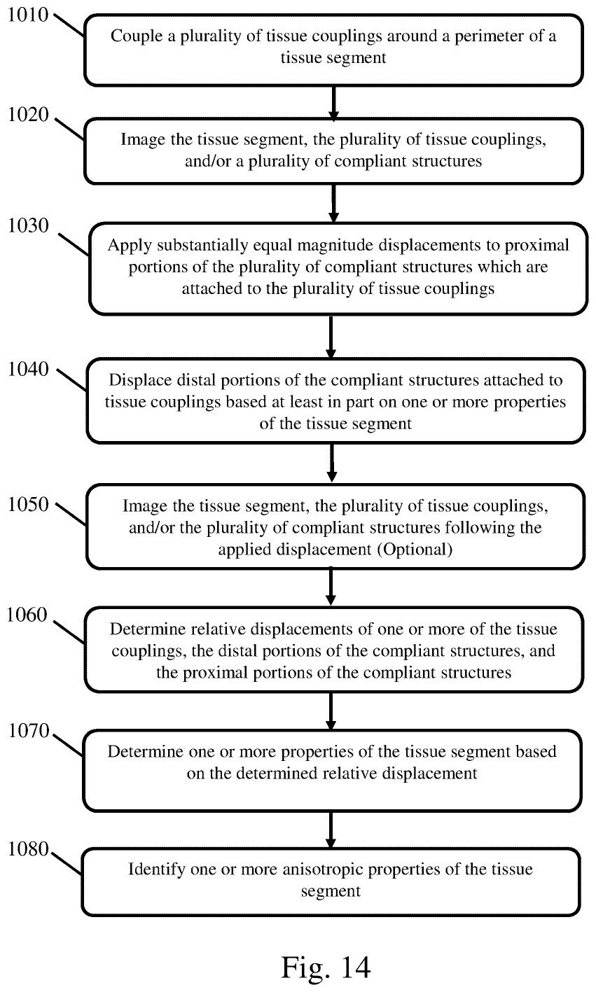

According to some aspects of the disclosure, the embodiments disclosed herein may be embodied as a method. An exemplary method of testing a tissue segment is shown in FIG. 14. In step 1010, a plurality of tissue couplings may be coupled around a perimeter of the tissue segment. These tissue couplings may be of any suitable type, e.g., pins or clamps, and the tissue couplings may be attached to a plurality of compliant structures on an opposite end.

In step 1020, the tissue segment, the plurality of tissue couplings, and/or the plurality of the compliant structures may be imaged using a photosensitive detector to track the location of the compliant structures, the tissue couplings, and/or the tissue segment using a plurality of registration marks. In some embodiments, this imaging step may serve as a calibration image to which later imaging is compared to determine deformation in the tissue segment.

In step 1030, a substantially equal magnitude displacement may be applied to proximal portions of the plurality of compliant structures. This displacement may be achieved by actuating one or more actuators engaged with the proximal end of each of the compliant structures.

In step 1040, distal portions of the compliant structures may be displaced as a result of the displacement applied to the proximal portions of the compliant structures, thereby causing the tissue couplings which are attached to the distal portions of the compliant structures to also displace. In some embodiments, the displacement may be based on at least in part one or more anisotropic properties of the tissue segment. For example, tissue couplings and compliant structures attached to different portions of the tissue segment in different orientations may undergo different overall displacements. In one such instance, the tissue couplings and compliant structures may be attached to the tissue segment along a first axis and a second axis (e.g., two compliant structures and two tissue couplings opposing one another per axis). In such an example, the first axis of the tissue segment may be stiffer than the second axis, which may result in different degrees of deformation in the tissue segment following a displacement applied from the compliant structures. While such an example is disclosed, compliant structures and tissue couplings may be provided along any suitable number of axes of the tissue segment, and the tissue segment may experience similar or different displacements along different portions of the segment.

In step 1050, the tissue segment, the plurality of tissue couplings, and/or the plurality of compliant structures may be imaged by a photosensitive detector during and/or following the displacement applied to the tissue segment. For example, a first calibration image may be taken, followed by a series of images. The series of images may be of any suitable number as the disclosure is not so limited (e.g., 50 total image frames). The final image of the series of images may be compared to the initial calibration image to determine the overall deformation of the tissue segment. In some embodiments, the deformation may be calculated by using one or more registration marks which may be located on any of the tissue couplings and/or the compliant structures. The location of the registration marks may be tracked between images such that the deformation can be measured along any suitable point during the applied displacement. While registration marks and a photosensitive detector may be used as noted above, in other embodiments other suitable position sensors (e.g., strain gauges) may instead be used as disclosed herein. Additionally, tracking of the movement of unmarked portions of the tissue and/or device without the use of specific registration marks using other identifiable landmarks on the tissue and/or device are also contemplated as the disclosure is not so limited.

In step 1060, relative displacements of one or more of the tissue couplings, the distal portions of the compliant structures, and the proximal portions of the compliant structures may be determined using the imaging recorded with the photosensitive detector. As noted above, in some embodiments, registration marks may be positioned on the tissue couplings and/or the compliant structures and the location of the registration marks may be tracked during the image recording. The relative position of the registration marks between two given frames following displacement can thus be calculated because the initial location of the registration marks is known.

In step 1070, one or more anisotropic properties of the tissue segment may be determined based on the determined relative displacement in step 1060. In particular, by knowing the stiffness of the compliant structures, the applied displacement, the original length of the tissue segment, and the stretched length of the deformed tissue segment, properties of the tissue segment may be determined. As disclosed herein, the tissue couplings and compliant structures attached to different portions of the tissue segment in different orientations may undergo different overall displacements as a result of the varying anisotropic properties of the tissue segment at different portions of the segment.

In step 1080, the one or more anisotropic properties determined in step 1070 may be identified. The anisotropic properties may include, but are not limited to stress, strain, Young's Modulus, principal material direction, or any other suitable anisotropic properties. For example, it may be beneficial for the clinician to know which axes of the tissue segment exhibit the highest and the lowest stiffness values since the resulting deformation in the tissue segment along each of these axes will vary. The anisotropic properties described above may be output to the clinician such that the clinician may optimize implantation of the corresponding tissue segment. For example, as disclosed herein, one or more processors may be included with or separated from the photosensitive detector, and the processors may be configured to analyze the anisotropic properties of the tissue segment based on its deformation which may then be output to the clinician. In some embodiments, the collected data may be stored in a database for future recall, provided instantaneously to a user (e.g., via a display), or any other suitable form of data storage and output to the clinician as the disclosure is not so limited.

While an exemplary method has been provided herein in reference to FIG. 14, any embodiments of the disclosure may be embodied as a method as the disclosure is not so limited. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

1. A device for testing a material segment comprising:
a plurality of tissue couplings configured to be selectively engaged with the material segment around a perimeter of the material segment;
one or more actuators; and
a plurality of compliant structures configured to operatively couple the one or more actuators with the plurality of tissue couplings,
wherein the one or more actuators are configured to apply an approximately equal magnitude displacement to a proximal portion of each compliant structure of the plurality of compliant structures.

2. The device of claim 1, wherein the displacement applied to the proximal portion of each compliant structure is configured to displace at least a portion of each compliant structure in a direction that is directed at least partially radially outwards from the material segment.

3. The device of claim 1, wherein the displacement applied to the proximal portion of each compliant structure is at least one selected from the group of translation and rotation of at least a portion of each compliant structure operatively coupled to the one or more actuators.

4. The device of claim 1, wherein the displacement applied to the proximal portions of each compliant structure is configured to displace each tissue coupling of the plurality of tissue couplings, and wherein an amount of the displacement of each tissue coupling and a corresponding portion of a compliant structure of the plurality of compliant structures attached to each tissue coupling is dependent on one or more anisotropic properties of the material segment.

5. The device of claim 1, wherein the plurality of compliant structures includes at least one of springs, compliant arms, and elastomers.

6. The device of claim 1, wherein the one or more actuators and the plurality of compliant structures are configured to apply a force to the material segment less than a plastic deformation threshold of the material segment.

7. The device of claim 1, further comprising:
a photosensitive detector configured to image the plurality of tissue couplings and the plurality of compliant structures; and
one or more processors configured to receive a signal from the photosensitive detector,
wherein the one or more processors are configured to determine displacements and/or forces applied to each tissue coupling of the plurality of tissue couplings.

8. The device of claim 7, wherein the one or more processors are configured to determine one or more anisotropic properties of the material segment based at least in part on the displacements and/or forces applied to each tissue coupling.

9. The device of any one of claims 1-8, further comprising a plurality of registration marks associated with the plurality of compliant structures.

10. The device of claim 1, further comprising:
a rotatable cam plate having a plurality of cam profiles formed therein; and
a plurality of cams attached to the proximal portions of the plurality of compliant structures,
wherein rotation of the rotatable cam plate relative to the compliant structures applies the approximately equal magnitude displacement to the proximal portion of each compliant structure of the plurality of compliant structures.

11. The device of claim 1, wherein the plurality of tissue couplings are engaged with the material segment using at least one of pin, clamps, tines, teeth, sutures, hooks, and brackets.

12. The device of claim 1, wherein the one or more actuators are operatively linked with at least one of the plurality of compliant structures via at least one of a pulley, a piston, a plunger, a rack and pinion, one or more gears, a cable, one or more linkages, a screw, and a chain.

13. The device of claim 1, wherein the device is configured for use in an ex-vivo environment.

14. A method of testing a material segment, the method comprising:
attaching a plurality of tissue couplings around a perimeter of the material segment at a plurality of attachment points;
displacing proximal portions of a plurality of compliant structures attached to the tissue couplings away from the material segment, wherein each proximal portion of the plurality of compliant structures is displaced by an approximately equal magnitude displacement; and
applying forces to the material segment in a plurality of different directions with the plurality of tissue couplings, wherein the forces and resulting displacements of the plurality of tissue couplings is dependent on one or more properties of the material segment.

15. The method of claim 14, further comprising displacing at least a portion of each compliant structure in a direction that is directed at least partially radially outwards from the material segment in response to the displacement applied to the proximal portions of the plurality of compliant structures.

16. The method of claim 14, wherein displacing proximal portions of the plurality of compliant structures includes at least one of translating and rotating at least a portion of each compliant structure operatively coupled to the one or more actuators.

17. The method of claim 14, wherein the plurality of compliant structures includes at least one of springs, compliant arms, and elastomers.

18. The method of claim 14, further comprising applying a force to the material segment less than a plastic deformation of the material segment with one or more actuators and the plurality of compliant structures.

19. The method of claim 14, further comprising:
imaging the plurality of tissue couplings and the plurality of compliant structures using a photosensitive detector;
receiving a signal from the photosensitive detector using one or more processors; and
determining displacements and/or forces applied to each tissue coupling of the plurality of tissue couplings using the one or more processors.

20. The method of claim 19, further comprising determining one or more anisotropic properties of the material segment based at least in part on the displacements and/or forces applied to each tissue coupling.

21. The method of any one of claims 14-20, further comprising providing a plurality of registration marks associated with the plurality of compliant structures.

22. The method of claim 14, further comprising:
attaching a plurality of cams to the proximal portions of the plurality of compliant structures; and
rotating a rotatable cam plate having a plurality of cam profiles formed therein relative to the plurality of compliant structures such that each of the proximal portions of the plurality of compliant structures is displaced by the approximately equal magnitude displacement.

23. The method of claim 14, wherein attaching the plurality of tissue couplings around the perimeter of the material segment includes attaching using at least one of pins, clamps, tines, teeth, sutures, hooks, and brackets.

24. The method of claim 14, further comprising applying a force to the material segment with one or more actuators and the plurality of compliant structures, wherein the one or more actuators are operatively linked with at least one of the plurality of compliant structures via at least one of a pulley, a piston, a plunger, a rack and pinion, one or more gears, a cable, one or more linkages, a screw, and a chain.

25. The method of claim 14, wherein the method of testing the material segment is conducted in an ex-vivo environment.

26. The method or device of any one of the preceding claims, wherein the material segment is a biomaterial segment.

27. The method or device of claim 26, wherein the biomaterial segment is a tissue segment.

28. The method or device of any one of the preceding claims, wherein the material segment is a compliant planar material segment.
